(19) United States
(12) Patent Application Publication
(10) Pub. No.: US 2026/0225422 A1
(43) Pub. Date: Aug. 6, 2026

(54) ROBOT MOBILITY SYSTEMS

(71) Applicant: COLLABORATIVE ROBOTICS, Santa Clara, CA (US)

(72) Inventors: Alan Baird, Santa Clara, CA (US); Jon Stevens, Santa Clara, CA (US)

(21) Appl. No.: 19/532,901

(22) Filed: Feb. 6, 2026

Related U.S. Application Data
(60) Provisional application No. 63/755,122, filed on Feb. 6, 2025.

(51) Int. Cl. B60G 17/0165; B60G 3/20; B60G 11/18

(52) U.S. Cl. CPC B60G 17/0165; B60G 3/20; B60G 11/18; B60G 2200/18; B60G 2202/13; B60G 2500/30

(57) ABSTRACT

A robot may include a body and a mobility system. The mobility system may include a multi-link system coupled to the body. The multi-link system may form a kinematic chain to control movement of the multi-link system. The mobility system may include an actuator coupled to a particular link of the multi-link system. The actuator may drive the particular link and move the multi-link system in a single dimension relative to the body for interaction of the robot with a feature.

### CROSS-REFERENCE TO RELATED APPLICATION

This patent application claims the benefit of and priority to U.S. Provisional App. No. 63/755,122 filed Feb. 6, 2025 titled “ROBOT MOBILITY SYSTEMS,” which is incorporated in the present disclosure by reference in its entirety.

### FIELD

Embodiments described herein relate to robot mobility systems.

### BACKGROUND

Unless otherwise indicated in the present disclosure, the materials described in the present disclosure are not prior art to the claims in the present application and are not admitted to be prior art by inclusion in this section.

A robot may operate in diverse environments such as manufacturing facilities, warehouses, logistic facilities, or delivery systems. The robot may include a mobility system that allows it to move (e.g., navigate) within these environments. These environments may include features such as obstacles, corners, or transitions that affect mobility and stability of the robot. For example, these environments may include a threshold or a curb that create vertical transitions for the robot to navigate.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One or more embodiments of the present disclosure may include a robot including a body and a mobility system. The mobility system may include a multi-link system coupled to the body. The multi-link system may form a kinematic chain to control movement of the multi-link system. The mobility system may include an actuator coupled to a particular link of the multi-link system. The actuator may drive the particular link and move the multi-link system in a single dimension relative to the body for interaction of the robot with a feature.

One or more embodiments of the present disclosure may include a robot including a body and a mobility system. The mobility system may include a virtual four bar link system including a first link and a second link. The first link may be coupled to the body. The second link may be coupled to the first link. The mobility system may include an actuator coupled to the first link. The actuator may drive the first link to move the virtual four bar link system relative to the body in multiple dimensions for interaction of the robot with a feature.

The object and advantages of the embodiments will be realized and achieved at least by the elements, features, and combinations particularly pointed out in the claims. Both the foregoing general description and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 illustrates a block diagram of an example operational environment that includes a robot with a mobility system to allow the robot to interact with features of the environment;

FIG. 2 illustrates an example of the robot of FIG. 1 in which the limbs of the mobility system include multi-link systems;

FIG. 3 illustrates the example robot of FIG. 2 traversing a feature;

FIG. 4 illustrates an example of the robot of FIG. 1 in which the limbs include the multi-link systems;

FIG. 5 illustrates an example of the robot of FIG. 1 in which the limbs of the mobility system include virtual four bar link systems;

FIG. 6 illustrates an example of the robot of FIG. 1 that includes a passive suspension system;

FIGS. 7A and 7B illustrate an example of the robot of FIG. 1 in which the mobility system functions as a standing system;

FIG. 8 illustrates an example computing system that may be used to control the mobility system of the robot of FIG. 1,

all according to at least one embodiment described in the present disclosure.

### DETAILED DESCRIPTION

Robots may include mobility systems designed to handle different features. For example, the mobility system may allow the robot to traverse a feature (e.g., a raised threshold) or navigate a feature (e.g., a turn) while maintaining stability of the robot. The mobility system may manage loads due to the robot impacting these features. The features include but are not limited thresholds, surface transitions, ramps, curbs, stair edges, corners, boxes, carts, sloped surfaces, uneven surfaces, debris, or any other appropriate feature

Some mobility systems may include Ackermann steering systems that include large turning radii and that struggle to adjust orientation or direction of travel of the robot. Differential steering systems may provide improved maneuverability but may lack the ability to independently control body height, pitch, or roll relative to the ground surface. Some mobility systems use fixed wheelbases and fixed suspension geometries. These mobility systems may be designed to operate on a limited number of classes of terrain and struggle when operating in different classes of terrain.

The present disclosure discloses robots (e.g., a collaborative robot) that include mobility systems that permit the robot to traverse three-dimensional environments or a variety of environments. The environments may be three-dimensional because of bumps, transitions, obstacles, discontinuities, or any other item that creates uneven surfaces. For example, the environment may include a bump or transition between a floor and an elevator that is 0.5 inches or taller, which may cause the robot to traverse the bump using the mobility systems.

Embodiments described in the present disclosure may include mobility systems that are driven using actuators to cause limbs to function as suspension systems or holonomic drive systems. As another example, the robot may include wheels (e.g., swerve drive wheels, mecanum wheels, or independently driven/steered wheels) that operate as the holonomic drive systems. As used in the present disclosure, a holonomic drive system permits the robot to turn (e.g., go around a corner) or otherwise move without changing the way the robot is facing. In other words, the holonomic system may permit the robot to move within the environment while facing generally the same direction.

The limbs may permit a position of the limbs or corresponding wheels relative to a body of the robot to be changed. Changing the position of the limbs or the corresponding wheels relative to the body of the robot may permit the robot to drive over features, step on or over features, or both. Additionally or alternatively, the limbs may permit a position of the body of the robot relative to a surface to be changed. For example, the limbs may cause an angle of the body relative to the surface to change to accommodate traversing a sloped surface.

The wheels may form a swerve drivetrain (e.g., an omnidirectional drivetrain) in which one or more wheels are independently steered, driven (e.g., provided power to go forward or backwards), or both. Additionally or alternatively, the wheels may include mecanum wheels that include multiple rollers attached at an angle which enable omnidirectional motion of the system when the wheels are rotated synchronously or asynchronously in similar or opposite directions. The wheels may permit the robot to spin on a spot, drive sideways (relative to a direction the robot is facing), drive diagonally (relative to a direction the robot is facing), or at any other angle. Therefore, the swerve drivetrain may provide more mobility for the robot (e.g., angles at which it can drive) compared to an Ackermann steering system or a differential steering system.

One or more embodiments of the present disclosure may include a robot that includes a body and a mobility system. The mobility system may include a multi-link system that is coupled to the body. The multi-link system may form a kinematic chain to control movement of the multi-link system. The mobility system may include an actuator coupled to a particular link of the multi-link system. The actuator may drive the particular link and move the multi-link system in a single dimension relative to the body for interaction of the robot with a feature.

One or more embodiments of the present disclosure may include a robot that includes a body and a mobility system. The mobility system may include a virtual four bar link system that includes a first link and a second link. The first link may be coupled to the body. The second link may be coupled to the first link. The mobility system may include an actuator coupled to the first link. The actuator may drive the first link to move the virtual four bar link system relative to the body in multiple dimensions for interaction of the robot with a feature.

The mobility systems described in the present disclosure may permit the robot to be scaled for different operating environments. In addition, the mobility systems may be capable of traversing a wider range of terrain types compared to robots with rigid limbs.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

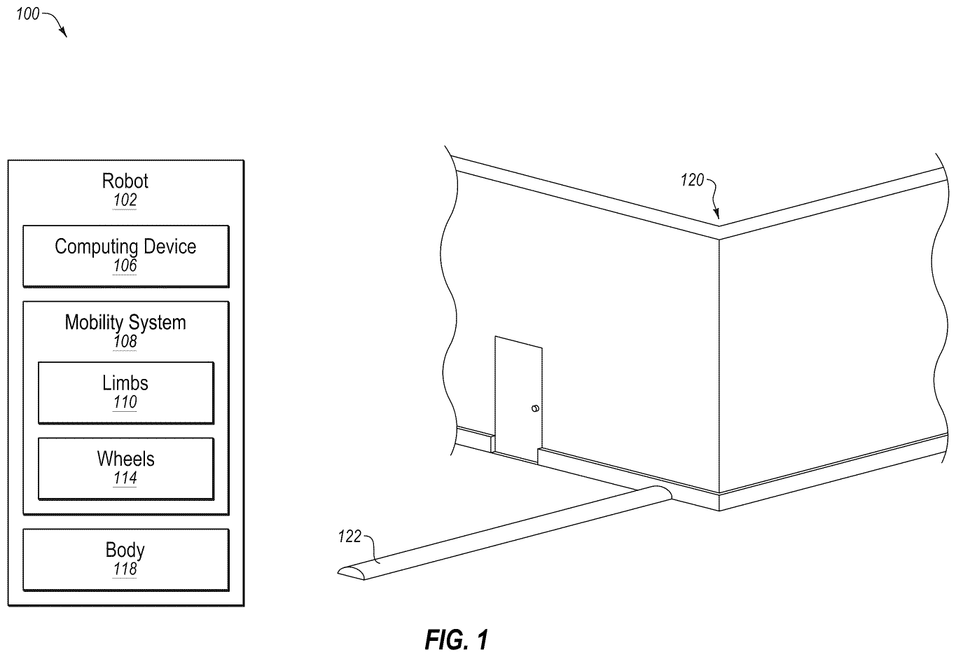

FIG. 1 illustrates a block diagram of an example operational environment 100 that includes a robot 102 with a mobility system 108 to allow the robot 102 to interact with features 120, 122 of the environment 100, in accordance with at least one embodiment described in the present disclosure. The robot 102 interacting with the feature 122 may include wheels 114 of the robot 102 traversing or stepping on or over the feature 122. Additionally or alternatively, the robot 102 interacting with the feature 120 may include the robot 102 navigating a corner. The operations described in the present disclosure may be implemented to cause the robot 102 to traverse or handle any appropriate feature such as a sloped surface or a load being placed on the robot 102.

The robot 102 may include a body 118 and the mobility system 108. The mobility system 108 may include limbs 110 and the wheels 114. The wheels 114 may be coupled to the limbs 110. Each wheel 114 may be coupled to a different instance of the limbs 110. In some embodiments, one or more of the wheels 114 include passive wheels and one or more of the wheels 114 include roller wheels (e.g., driven wheels). The wheels 114 may include swerve drive wheels to control steering of the robot 102. Additionally or alternatively, the wheels 114 may include mecanum wheels.

The robot 102 may steer the wheels 114 independent of driving the wheels 114 to permit steering of the robot 102 that is independent of propulsion of the robot 102. In addition, the robot 102 may drive the wheels 114 independent of steering the wheels 114 to permit propulsion of the robot 102 that is independent of steering the robot 102. The wheels 114 may include compliant tires or materials to provide suspension for the robot 102.

The wheels 114 may include removable wheel brushes or cleaners (not shown) to remove or clean debris, dirt, rubble, or other objects from the wheels 114. The wheel brushes or cleaners may remove or clean the objects while the wheels 114 are rotating. The wheel brushes or cleaners may include a brush, a straight edge, a roller including sticky material, or any other device configured to contact the wheels 114 and remove or clean the objects from the wheels 114.

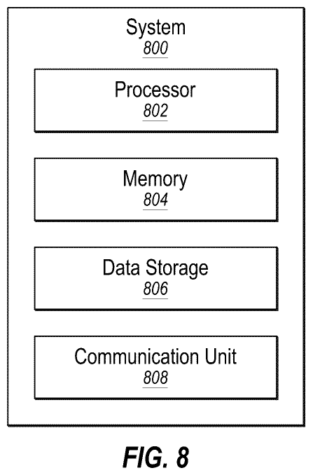

The robot 102 may include a computing device 106 configured to control operation of the mobility system 108 (e.g., cause actuators to drive portions of the limbs 110). The computing device 106 may include a desktop computer, a laptop computer, a smartphone, a mobile phone, a tablet computer, a server, a processing system, or any other computing system or set of computing systems that may be used for performing the operations described in the present disclosure. An example of such a computing device is described below with reference to FIG. 8. The computing device 106 may include a processor (not shown) and a storage medium (not shown).

The processor may include a central processing unit (CPU), a microprocessor (μP), a microcontroller (μC), a digital signal processor (DSP), a field-programmable gate array (FPGA), an application-specific integrated circuit (ASIC), or any combination thereof. The processor may be configured to execute computer instructions that, when executed, cause the processor or the computing device 106, to perform or control performance of one or more of the operations described herein with respect to operation of the robot 102. The processor may be implemented using a combination of hardware and software. In the present disclosure, operations described as being performed by the processor or the computing device 106 may include operations that the processor or the computing device 106 directs a corresponding system to perform.

The storage medium may include a storage medium such as a RAM, persistent or non-volatile storage such as ROM, EEPROM, CD-ROM, or other optical disk storage, magnetic disk storage or other magnetic storage device, NAND flash memory or other solid state storage device, or other persistent or non-volatile computer storage medium. The storage medium may store computer instructions that may be executed by the processor or the computing device 106 to perform or control performance of one or more of the operations described herein with respect to operation of the robot 102.

As described in more detail below, in some embodiments, the limbs 110 may include multi-link systems that form kinematic chains to control movement of the limbs 110. Alternatively, as described in more detail below, in some embodiments, the limbs 110 may include virtual four bar link systems that include multiple bars or links. Further, the limbs 110 may include suspension systems that are configured to absorb energy, dampen motion, or both when the wheels 114 contact the feature 122.

The computing device 106 may control the mobility system 108 to cause the limbs 110 to prepare for the wheels 114 to contact the feature 122. In addition, the computing device 106 may control the mobility system 108 to cause the limbs 110 to step on or over the feature 122. The computing device 106 may determine a trajectory for one of the wheels 114 to clear the feature 122. The computing device 106 may cause a particular part of one the limbs 110 to raise the corresponding wheel 114 vertically. The computing device 106 may cause another part of the limb 110 to move the wheel 114 horizontally. The computing device 106 may coordinate the movement of the limbs 110 to position the wheel 114 above or beyond the feature 122.

The computing device 106 may cause the limbs 110 to move to lower the wheel 114. The computing device 106 may repeat this process for one or more additional limbs 110 and wheels 114 to have the robot 102 step on or over the feature 122. The computing device 106 may also cause the limbs 110 to move to control an orientation of the robot 102 while the robot 102 is stepping on or over the feature 122.

In some embodiments, the computing device 106 may control the mobility system 108 to operate as an active suspension system in anticipation of or when the wheels 114 contact the feature 122 (e.g., a speed bump or other transition or obstacle). The computing device 106 may cause positions of the limbs 110 to change in preparation for and/or in response to the wheels 114 contacting the feature 122. For example, the computing device 106 may cause the limbs 110 to compress in a vertical direction to reduce force transmission to the body 118. As another example, the computing device 106 may cause the limbs 110 to move in a horizontal direction to maintain a particular wheelbase of the robot 102. In other embodiments, the limbs 110 may operate as passive suspension systems when the wheels 114 contact the feature 122.

The computing device 106 may control the mobility system 108 to a center of mass or orientation of the robot 102 while navigating the feature 120 (e.g., navigating a corner) to maintain stability of the robot 102. The computing device 106 may determine a trajectory for the robot 102 to follow while turning around the feature 120. The computing device 106 may cause the limbs 110 to move to shift the center of mass of the robot 102. For example, the computing device 106 may cause the limbs 110 on a first side of the body 118 to extend and the limbs 110 on a second side of the body 118 to retract. The computing device 106 may coordinate the movement of the limbs 110 to lean the body 118 into the turn. Additionally or alternatively, the computing device 106 may adjust the wheelbase of the robot 102 by moving the limbs 110 to move one or more of the wheels 114 forward or backward relative to the body 118. The computing device 106 may dynamically adjust the center of mass or orientation of the robot 102 throughout the turn to prevent tipping or loss of traction or dropping an object that the robot 102 is carrying.

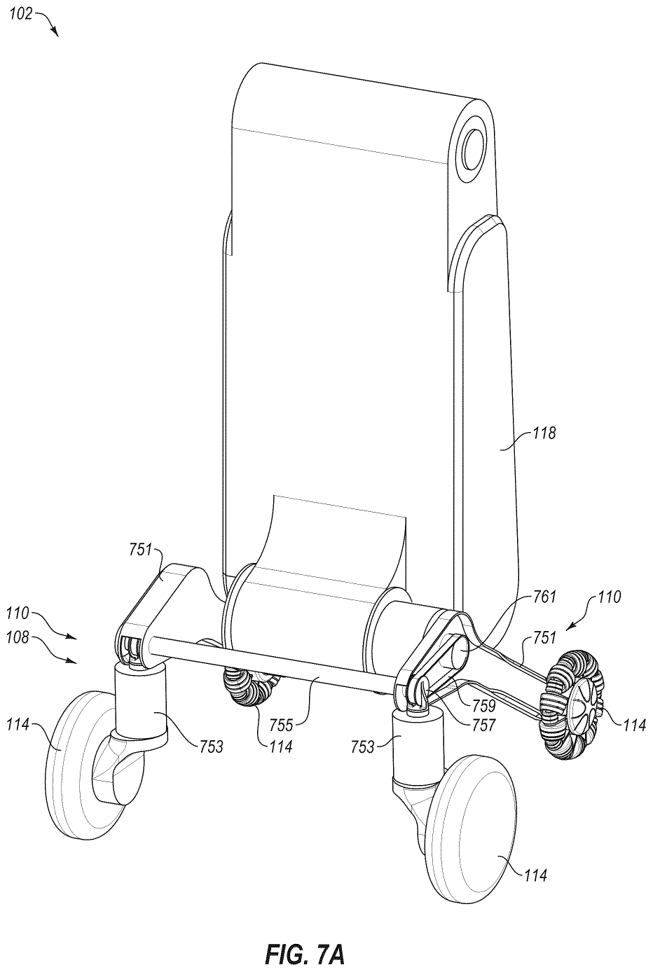

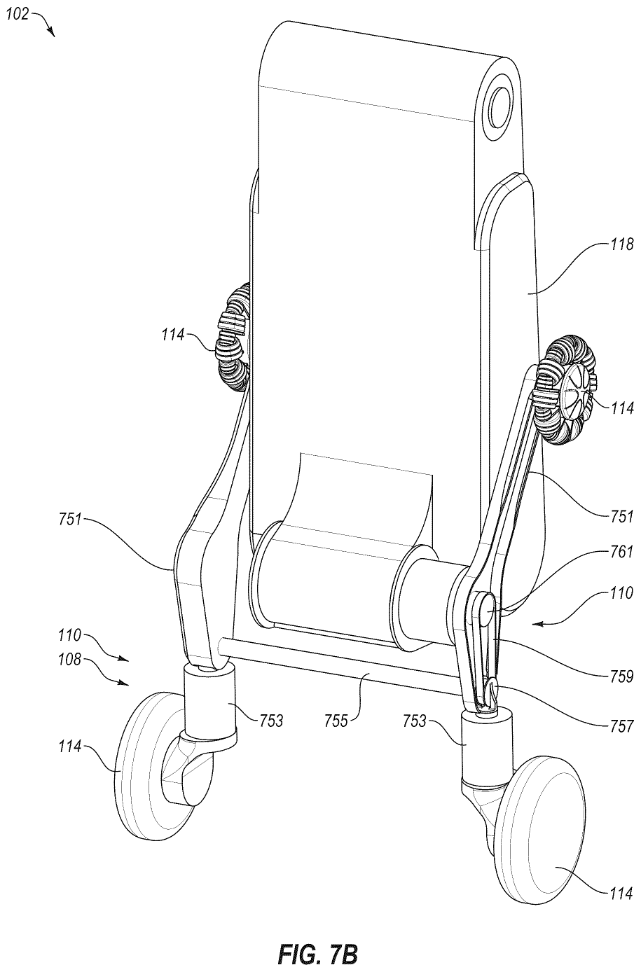

The computing device 106 may control the mobility system 108 to cause the robot 102 to transition between a default state and a standing state. The default state and the standing state are described in more detail below in relation to FIGS. 7A and 7B. In the default state, all of the wheels 114 may contact a surface. To transition to standing state, the computing device 106 may cause the limbs 110 to move such that a portion of the wheels 114 are positioned beneath the center of mass of the robot 102 and another portion of the wheels are not contacting the surface. The computing device 106 may reverse this sequence to transition to the default state from the standing state. The computing device 106 may coordinate the movement of the limbs 110 to maintain stability of the robot 102 throughout the transition. The computing device 106 may cause the robot 102 to balance on the portion of the wheels 114 in the standing state to reduce a footprint of the robot 102. For example, the computing device 106 may cause the robot 102 to operate in the standing state so that the robot 102 can fit in an elevator or other location with limited space.

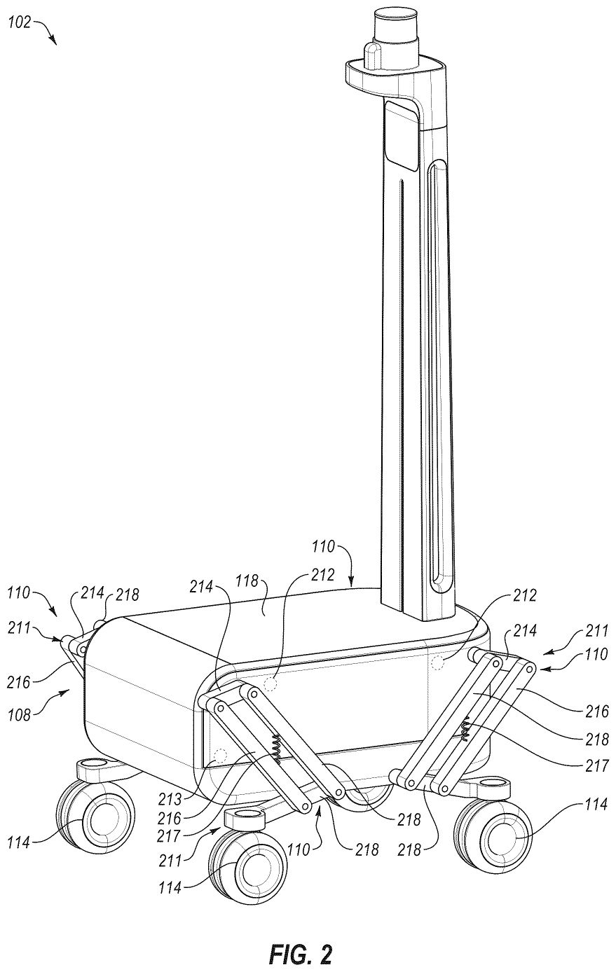

FIG. 2 illustrates an example of the robot 102 of FIG. 1 in which the limbs 110 of the mobility system 108 include multi-link systems 211, in accordance with at least one embodiment described in the present disclosure. With reference to FIGS. 1 and 2, the multi-link systems 211 may be coupled to the body 118 to move relative to the body 118 (e.g., a link 214 may be coupled to the body 118 to rotate). As shown in FIG. 2, the multi-link systems 211 may include links 214, 216, 218 arranged as a four-bar link system.

The multi-link systems 211 may form kinematic chains to constrain motion of the multi-link systems 211 to specific dimensions while permitting controlled movement of the multi-link systems 211 through ranges of motion within those dimensions. The kinematic chain may define mechanical relationships between the links 214, 216, 218 such that movement of one of the links 214, 216 causes predictable, coordinated movement of other links 214, 216, 218. The kinematic chain may limit degrees of freedom of the individual links 214, 216, 218.

The links 214, 216, 218 may be coupled to one or more of the other links 214, 216, 218 or the body 118 via joints to permit the links 214, 216, 218 to pivot or rotate relative to the joints. The links 214, 216, 218 pivoting or rotating relative to the joints may cause angles, orientations, positions, or any other appropriate aspect of the multi-link systems 211 to change relative to the body 118, the surface, or both.

The mobility system 108 may include actuators 212, 213. The actuators 212 may be coupled to the links 214 and configured to drive the links 214. The actuators 212 may drive the links 214 to move the multi-link system 211 in a first dimension (e.g., a single dimension). The actuators 213 may be coupled to the links 216 and configured to drive the links 216. The actuators 213 may drive the links 216 to move the multi-link system 211 in a second dimension (e.g., an additional dimension).

The actuators 212, 213 may drive the links 214, 216 (e.g., cause the links 214, 216 to pivot or rotate) to move the multi-link systems 211, the wheels 114, or both in one or more dimensions for interaction of the robot 102 with the features 120, 122. For example, the actuators 212 may drive the links 214 to cause the multi-link systems 211, the wheels 114, or both to move vertically relative to the body 118 (e.g., along a Z plane) for interaction of the robot 102 with the features 120, 122. As another example, the actuators 213 may drive the links 216 to cause the multi-links systems 211 to move horizontally (e.g., along an X plane) relative to the body 118 for interaction of the robot 102 with the features 120, 122.

The actuators 212, 213 may drive the links 214, 216 to adjust a wheelbase of the robot 102. In FIG. 2, the robot 102 is shown in a default state with the wheels 114 equally spaced relative to each other and the body 118. As described in more detail below, the actuators 212, 213 may drive the links 214, 216 to adjust the wheelbase to a variety of positions.

The actuators 212, 213 may independently drive the links 214, 216 to provide independent operations of the individual multi-link systems 211. For example, the actuators 212, 213 may drive the links 214, 216 of left multi-link systems 211 (e.g., the multi-link systems 211 closest to a viewer of FIG. 1) independent of the actuators 212, 213 driving the links 214, 216 of right multi-link systems 211.

The actuators 212, 213 may drive the links 214, 216 to cause the multi-link systems 211 to operate as active suspension systems for interacting with the feature 122. The multi-link systems 211 may operate as the active suspension systems to prepare for or respond to the wheels 114 contacting the feature 122. The actuators 212, 213 may drive the links 214, 216 to cause the multi-link systems 211 to move or position the multi-link systems 211 in anticipation of contacting the feature 122. In addition, the actuators 212, 213 may drive the links 214, 216 to permit the multi-link systems 211 to move in response to the wheels 114 contacting the feature 122.

The actuators 212, 213 may drive the links 214, 216 to provide step-like movements by the multi-link systems 211. The actuators 212, 213 may drive the links 214, 216 to cause the multi-link systems 211 to cause the wheels 114 to step on or over the feature 122. For example, the actuators 212 may drive the links 214 to move or lift the wheels 114 to a height that is equal to or greater than a height of the feature 122. In addition, the actuators 213 may drive the links 216 to move the wheels 114 horizontally to be positioned on, above, or beyond the feature 122.

The actuators 212, 213 may drive the links 214, 216 to coordinate motion across the multi-link systems 211 such that the robot 102 may maintain stability while one or more of the wheels 114 is moved. Additionally or alternatively, the actuators 212, 213 may drive the links 214, 216 to position the center of mass of the robot 102 as the robot 102 steps. The center of mass of the robot 102 may be positioned to account for a shift in weight when the wheels 114 are lifted or moved.

The actuators 212, 213 may drive the links 214, 216 to control orientation of the body 118 relative to a surface over which the robot 102 is traversing. For example, the actuators 212, 213 may drive the links 214, 216 to adjust a pitch, a roll, or both of the body 118 relative to the surface. As another example, the actuators 212, 213 may drive the links 214, 216 to raise or lower the body 118 relative to the surface.

The actuators 212, 213 may drive the links 214, 216 to position or shift the center of mass of the robot 102 to control performance of the robot 102. The center of mass of the robot 102 may be positioned relative to contact points of the wheels 114, the surface over which the robot 102 is traversing, or both. The center of mass of the robot 102 may be positioned to account for movement of the robot 102. For example, the actuators 212, 213 may drive the links 214, 216 to position the center of mass of the robot 102 towards a back of the robot 102 in preparation for the robot 102 to decelerate or while the robot 102 is decelerating. As another example, the actuators 212, 213 may drive the links 214, 216 to position the center of mass of the robot 102 towards a front of the robot 102 in preparation for the robot 102 to accelerate or while the robot 102 is accelerating.

The mobility system 108 may include passive components 217 that are coupled to two of the links 216, 218. The passive components 217 may include springs, dampers, or torsion devices configured to store or release energy due to the wheels 114 contacting the feature 122. The passive components 217 may compress or deflect in response to forces transmitted through the wheels 114 when contacting the feature 122. The passive components 217 may extend to cause the wheels 114 to maintain contact while the wheels 114 traverse the feature 120.

The passive components 217 may operate in combination with the actuators 212, 213 to provide passive operations in addition to the active operations provided by the actuators 212, 213. In some embodiments, the passive components 217 may be omitted and only the operations of the actuators 212, 213 may control mobility of the robot 102. In other embodiments, the actuators 212, 213 may be omitted and the passive components 217 may independently operate as passive suspension systems for the multi-link systems 211.

The wheels 114 contacting the feature 122 may cause the links 214, 216, 218 to pivot or rotate relative to the joints to apply a force on the passive components 217. The passive components 217 may enable general one-dimensional movement (e.g., vertical movement) of the wheels 114 in response to contacting the feature 122.

The passive components 217 may be coupled to the links 216, 218 to absorb energy created by the wheels 114 contacting the feature 122. The passive components 217 may provide independent suspension operations for individual instances of the multi-link systems 211. For example, the passive component 217 of a left multi-link system 211 may absorb energy created by the wheel 114 contacting the feature 122 independent of the passive component 217 of a right multi-link system 211 absorbing energy created by the wheel contacting the feature 122.

In some embodiments, the passive component 217 may include suspension assemblies that are configured to operate as torsion devices. When the wheels 114 contact the feature 122, the links 214, 216, 218 may move and cause the torsion device to store energy or release energy to function as a suspension device. For example, the torsion device may include a torsion spring that winds up or winds down to store or release energy due to the wheels 114 contacting the feature 122.

The mobility system 108 is illustrated in FIG. 2 as including one instance of the passive components 217 per multi-link system 211. In some embodiments, the mobility system 108 may include two or more instances of the passive components 217 for one or more of the multi-link systems 211.

In some embodiments, as shown in FIG. 2, the actuators 212, 213 may be positioned on or within the body 118 to reduce or prevent mass of the actuators 212, 213 from being positioned on the multi-link systems 211. Additionally or alternatively, the actuators 212, 213 may be positioned on or within the body 118 to reduce or prevent a number of cables extending between the body 118 and the multi-link systems 211.

As shown in FIG. 2, the mobility system 108 includes four instances of the actuators 212 and four instances of the actuators 213 (e.g., eight actuators 212, 213 in total). In some embodiments, the actuators 213 may be omitted and the mobility system 108 may only include the actuators 212 to drive the links 214. In these and other embodiments, the actuators 212 may drive the links 214 to cause the multi-links systems 211, the wheels 114, or both to move only in one dimension (e.g., vertical movement) relative to the body 118.

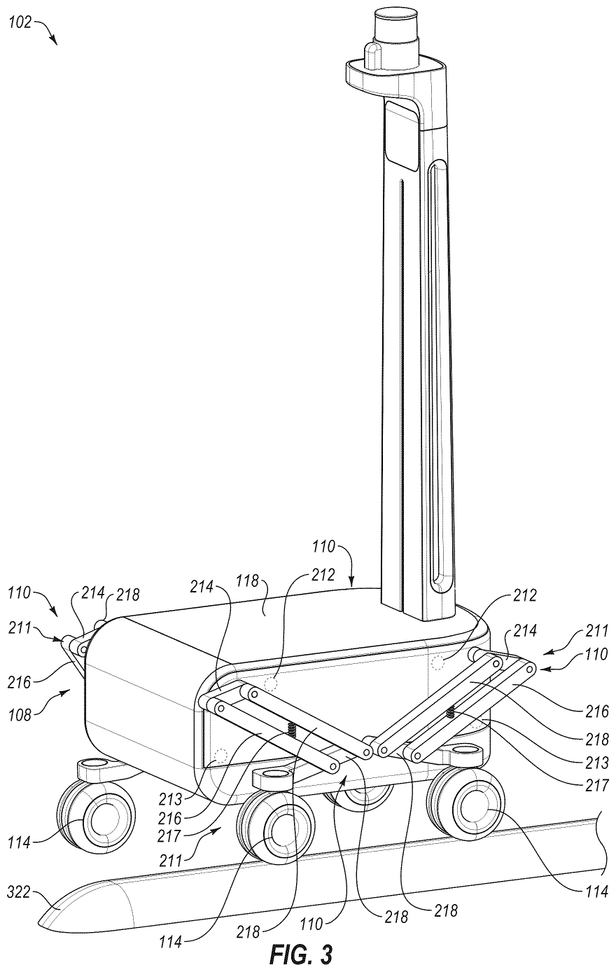

FIG. 3 illustrates the example robot 102 of FIG. 2 traversing a feature 322, in accordance with at least one embodiment described in the present disclosure. In FIG. 3, the mobility system 108 is shown in an offset and raised state in which the wheels 114 are offset in height and distance to each other. As shown in FIG. 3, left multi-link systems 211 (e.g., the multi-link systems 211 closest to the viewer of FIG. 3) are retracted (e.g., at a greater height) compared to right multi-link systems 211 on the opposite side of the body 118. In addition, the left wheels 114 are closer to each other than the right wheels 114 are to each other. The multi-link systems 211 may be in the offset and raised state shown in FIG. 3 to allow the left wheels to traverse or drive along the feature 322. The feature 322 of FIG. 3 may correspond to the feature 122 of FIG. 1.

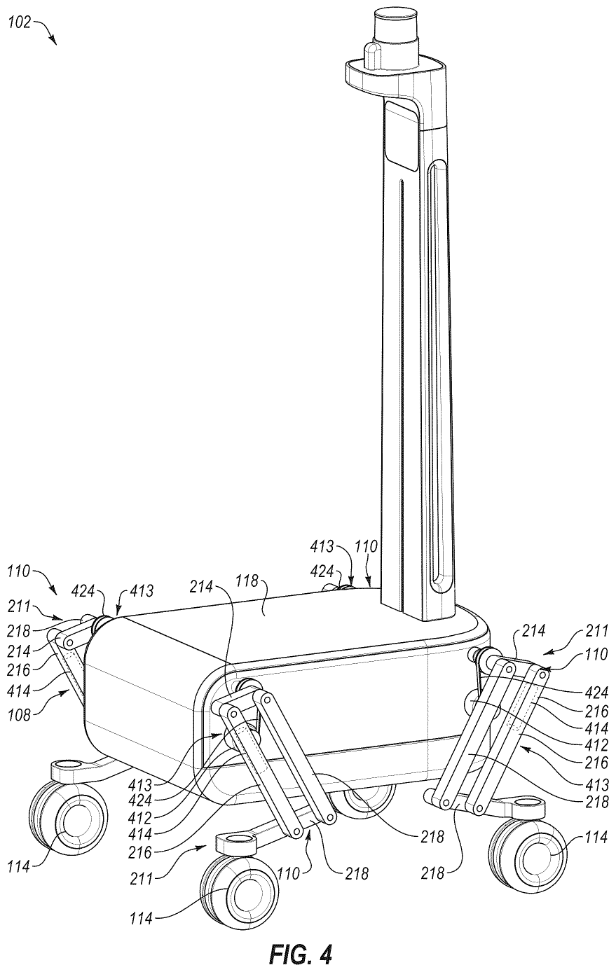

FIG. 4 illustrates an example of the robot 102 of FIG. 1 in which the limbs 110 include the multi-link systems 211, in accordance with at least one embodiment described in the present disclosure. As shown in FIG. 4, the multi-link systems 211 are driven by actuator assemblies 413 and actuators 414.

The actuator assemblies 413 may be coupled to the links 214 to drive the links 214. The actuator assemblies 413 may include belts 424 and actuators 412. The belts 424 may be connected to the links 214 and the actuators 412. The actuators 412 may cause the belts 424 to spin or rotate, which may cause one or more gears (not shown) or portions of the links 214 to spin to drive the links 214. The actuator assemblies 413 may drive the links 214 the same as or similar to the actuators 212 discussed above in relation to FIGS. 1-3.

The actuators 414 may be coupled to the links 216 to drive the links 216. As shown in FIG. 4, the actuators 414 may be positioned within the links 216. Alternatively, the actuators 414 may be positioned within the body 118. The actuators 414 may drive the links 216 the same as or similar to the actuators 213 discussed above in relation to FIGS. 1-3.

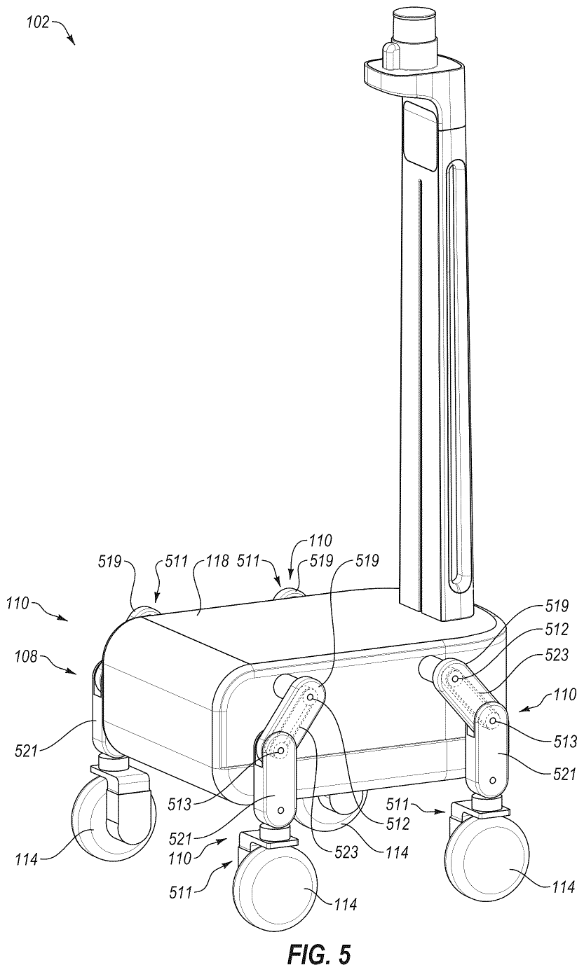

FIG. 5 illustrates an example of the robot 102 of FIG. 1 in which the limbs 110 of the mobility system 108 include virtual four bar link systems 511 (generally referred to in the present disclosure as “the four link systems 511”), in accordance with at least one embodiment described in the present disclosure. With reference to FIGS. 1 and 5, the four link systems 511 may be coupled to the body 118 (e.g., a link 519 may be coupled to the body 118 to rotate). The four link systems 511 may include links 519, 521, actuators 512, and passive components 513. As shown in FIG. 5, the actuators 512 are coupled to the passive components 513 via belts 523. The actuators 512 may be coupled to the passive components 513 using chains, wire ropes, or any other appropriate device.

The links 519, 521 may be coupled to each other via the passive components 513 to form joints and to permit the links 519, 521 to pivot or rotate relative to the joints. The links 519 may be coupled to the body 118 via joints. The links 519, 521 pivoting or rotating relative to the joints may cause angles, orientations, positions, or any other appropriate aspect of the four link systems 511 to change relative to the body 118, the surface, or both.

The actuators 512 may be coupled to the links 519 and configured to directly drive the links 519 (e.g., cause the links 519 to pivot or rotate). The actuators 512 may drive the links 519 to indirectly move or control the links 521. The arrangement of the actuators 512, the belts 523, and the passive components 513 may maintain vertical orientations of the links 521 even when the links 519 are positioned at different angles relative to the body 118.

The actuators 512 may drive the links 519 to move the four link systems 511, the wheels 114, or both in one or more dimensions for interaction of the robot 102 with the features 120, 122. For example, the actuators 512 may drive the links 519 to cause the four link systems 511, the wheels 114, or both to move vertically relative to the body 118 (e.g., along a Z plane), horizontally relative to the body 118 (e.g., along an X plane), or both.

The actuators 512 may drive the links 519 to adjust a wheelbase of the robot 102. For example, the actuators 512 may drive the links 519 to increase, decrease, or shift the wheelbase of the robot 102. The four link systems 511 may be configured to be positioned in a variety of wheelbase positions. As shown in FIG. 5, the four link systems 511 are positioned in an increased wheelbase position. Alternatively, the four link systems 511 can be positioned in a shifted wheelbase position, a vertical wheelbase position, or a combined wheelbase position.

In the vertical wheelbase position, the wheels 114 may be positioned substantially beneath the body 118 along a vertical plane. The actuators 512 may drive the links 519 such that the links 519, 521 are arranged in a generally vertical orientation (e.g., perpendicular) relative to a surface. The term “generally vertical” as used in the present disclosure may include any orientation within plus or minus ten degrees of a true vertical reference. The links 519, 521 may extend such that the wheels 114 are positioned below the links 521. The vertical wheelbase position may result in a reduced footprint of the robot 102 to fit within constrained spaces such as elevators or narrow passages. In the vertical configuration, no angle may be formed at the passive components 513, which prevents the four links systems 511 from operating as a suspension system.

In the increased wheelbase position, the wheels 114 may be positioned farther from a vertical center of the body 118 compared to the vertical wheelbase position. The actuators 512 may drive the links 519 such that the links 519, 521 form a non-parallel angle relative to each other. In addition, the actuators 512 may drive the links 519 to move the wheels forwards and backwards to increase a distance between the front wheels 114 and the rear wheels 114 compared to the vertical wheelbase position. The increased wheelbase position may provide enhanced stability for the robot 102 when navigating the environment 100, traversing uneven terrain, or when carrying objects.

In the shifted wheelbase position, the actuators 512 may drive the links 519 such that the front wheels 114 are positioned differently relative to the vertical center of the body 118 compared to the rear wheels 114. The shifted wheelbase may include a forward shifted wheelbase or a rear shifted wheelbase. In the forward shifted wheelbase, the links 519, 521 may be positioned to cause the front wheels 114 to move forward away from the vertical center of the body 118 and the rear wheels 114 to move forward towards the vertical center of the body 118. The forward shifted wheelbase may improve stability or performance of the robot 102 when the robot 102 is decelerating. In the rear shifted wheelbase, the links 519, 521 may be positioned to cause the rear wheels 114 to move backwards away from the vertical center of the body 118 and the front wheels 114 to move backwards towards the vertical center of the body 118. The rear shifted wheelbase may improve stability or performance of the robot 102 when the robot 102 is accelerating.

The combined wheelbase position may include the four link systems 511 being in positions corresponding to two or more of the increased wheelbase position, the shifted wheelbase position, or the vertical wheelbase position. The combined wheelbase position may improve stability and maneuverability for specific situations such as navigating across sloped surfaces.

The actuators 512 may independently drive the links 519 to provide independent operations of the individual four link systems 511. For example, the actuator 512 may drive the links 519 of left four link systems 511 (e.g., the four link systems 511 closest to a viewer of FIG. 5) independent of the actuators 512 driving the links 519 of right four link systems 511.

The actuators 512 may drive the links 519 to cause the four link systems 511 to operate as active suspension systems for interacting with the feature 122. In the increased wheelbase position as shown in FIG. 5, the four link systems 511 may form angles at the passive components 513 to permit the four link systems 511 to operate as suspension systems. In addition, in the shifted wheelbase position, the four link systems 511 may also form angles at the passive components 513 to permit the four link systems 511 to operate as suspension systems

The four link systems 511 may operate as the active suspension systems to prepare for or respond to the wheels 114 contacting the feature 122. The actuators 512 may drive the links 519 to cause the four link systems 511 to move or position the four link systems 511 in anticipation of the wheels 114 contacting the feature 122. In addition, the actuators 512 may drive the links 519 to permit the four link systems 511 to move in response to the wheels 114 contacting the feature 122.

The actuators 512 may drive the links 519 to provide step-like movements by the four link systems 511 to traverse single steps or other single features. The actuators 512 may drive the links 519 to cause the wheels 114 to step on or over the feature 122. For example, the actuators 512 may drive the links 519 to indirectly move the links 521 and move or lift the wheels 114 to a height that is equal to or greater than a height of the feature 122 and/or to be positioned on, above, or beyond the feature 122.

The actuators 512 may drive the links 519 to coordinate motion across the four link systems 511 such that the robot 102 may maintain stability while one or more of the wheels 114 are moved. Additionally or alternatively, the actuators 512 may drive the links 519 to position a center of mass of the robot 102 as the robot 102 steps. The center of mass of the robot 102 may be positioned to account for a shift in weight when the wheels 114 are lifted or moved.

The actuators 512 may drive the links 519 to control orientation of the body 118 relative to a surface over which the robot 102 is traversing. For example, the actuators 512 may drive the links 519 to adjust a pitch, a roll, or both of the body 118 relative to the surface. As another example, the actuators 512 may drive the links 519 to raise or lower the body 118 relative to the surface.

The actuators 512 may drive the links 519 to position or shift the center of mass of the robot 102 to control performance of the robot 102. The center of mass of the robot 102 may be positioned relative to contact points of the wheels 114, the surface over which the robot 102 is traversing, or both. The center of mass of the robot 102 may be positioned to account for movement of the robot 102. For example, the actuators 512 may drive the links 519 to position the center of mass of the robot 102 towards a back of the robot 102 in preparation for the robot 102 to decelerate or while the robot 102 is decelerating. As another example, the actuators 512 may drive the links 519 to position the center of mass of the robot 102 towards a front of the robot 102 in preparation for the robot 102 to accelerate or while the robot 102 is accelerating.

In some embodiments, as shown in FIG. 5, the actuators 512 may be positioned on or within the links 519. In other embodiments, the actuators 512 may be positioned on or within the body 118 to reduce or prevent the mass of the actuators 512 from being positioned on the four link systems 511. Additionally or alternatively, the actuators 512 may be positioned on or within the body 118 to reduce or prevent a number of cables extending between the body 118 and the four link systems 511.

In some embodiments, the actuators 512 may drive the links 519 to position the passive components 513 above the actuators 512 such that the body 118 is brought on to or closer to the surface.

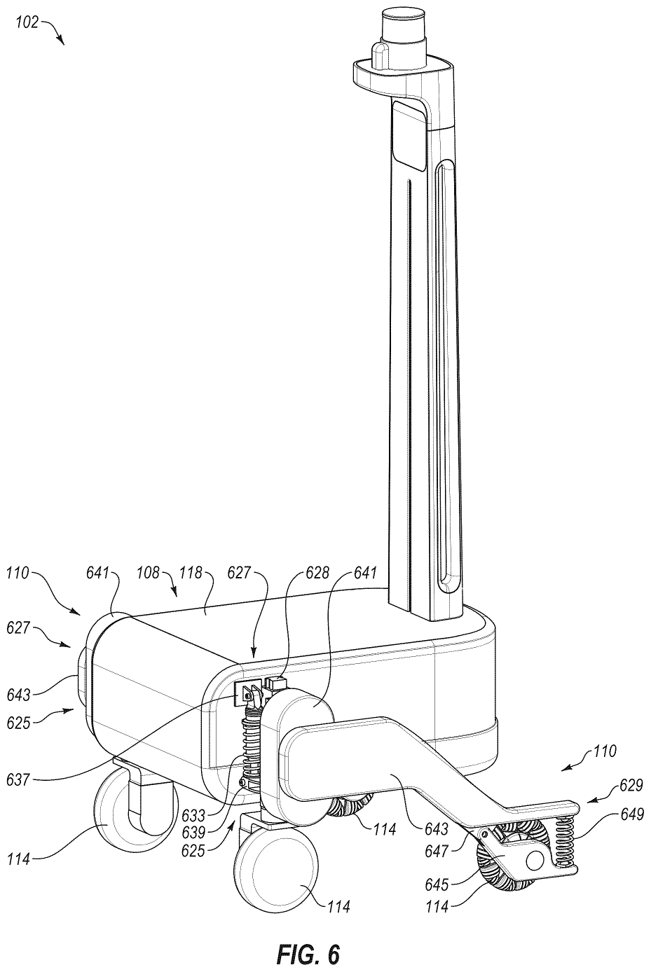

FIG. 6 illustrates an example of the robot 102 of FIG. 1 that includes a passive suspension system 625, in accordance with at least one embodiment described in the present disclosure. The passive suspension system 625 may include front suspension assemblies 627 and rear suspension assemblies 629. The wheels 114 may include roller wheels at a front of the mobility system 108 and passive wheels at a rear of the mobility system 108.

With reference to FIGS. 1 and 6, the passive suspension system 625 may absorb energy created by the front wheels 114 (e.g., the roller wheels) or the rear wheels 114 (e.g., the passive wheels) contacting the feature 122. For example, the front suspension assemblies 627 may absorb energy created by the front wheels 114 contacting the feature 122. As another example, the rear suspension assemblies 629 may absorb energy created by the rear wheels 114 contacting the feature 122.

The front suspension assemblies 627 may provide independent suspension for the front wheels 114. Additionally, the front suspension assemblies 627 may provide general one-dimensional movement of the front wheels 114. For example, the front suspension assemblies 627 may permit the front wheels 114 to move up or down in a vertical direction.

The front suspension assemblies 627 may be coupled between corresponding instances of the wheels 114 and the body 118. The front suspension assemblies 627 may include sliding mechanisms 628 that are coupled to the body 118 and to swerve drive assemblies 641 of the front suspension assemblies 627. The sliding mechanisms 628 may permit translational motion of the swerve drive assemblies 641 relative to the body 118. As described in more detail below, the translational motion of the swerve drive assemblies 641 relative to the body 118 may cause springs 633 of the front suspension assemblies 627 to compress or expand. The springs 633 may include coil over shocks, spring shocks, air shocks, elastomer springs, torsion springs, or some combination thereof.

The front suspension assemblies 627 may include top brackets 637 coupled to the body 118 and the springs 633. The front suspension assemblies 627 may also include bottom brackets 639 coupled to the springs 633 and the swerve drive assemblies 641. Movement of the swerve drive assemblies 641 may reduce or increase distances between the top brackets 637 and the bottom brackets 639, which will cause the springs 633 to compress or expand to absorb the energy created by the front wheels 114 contacting the feature 122. A spring rate of the springs 633 may control a rate of movement of the swerve drive assemblies 641 relative to the body 118.

The rear suspension assemblies 629 may provide independent suspension for the rear wheels 114. Additionally, the rear suspension assemblies 629 may provide general one-dimensional movement of the rear wheels 114. For example, the rear suspension assemblies 629 may permit the rear wheels 114 to move up or down in the vertical direction.

The rear suspension assemblies 629 may be coupled between the rear wheels 114 and support members 643 of the mobility system 108. The support members 643 may be coupled to and extend between the front suspension assemblies 627 (e.g., the swerve drive assemblies 641) and the rear suspension assemblies 629.

The rear suspension assemblies 629 may include rotational brackets 645. The rotational brackets 645 may be coupled to portions 647 of the support members 643, springs 649, or the rear wheels 114. The rotational brackets 645 may pivot around the portions 647 of the support members 643 to permit the rotational brackets 645 to move relative to the support members 643. As described in more detail below, the movement of the rotational brackets 645 relative to the support members 643 may cause the springs 649 to compress or expand.

The rotational brackets 645 may be coupled to the portions 647 of the support members 643 proximate to front distal ends of the rotational brackets 645. In addition, the rotational brackets 645 may be coupled to the springs 649 proximate to rear distal ends of the rotational brackets 645. The springs 649 may be coupled between the rotational brackets 645 and the support members 643. Movement of the rotational brackets 645 may reduce or increase a distance between the rotational brackets 645 and the support members 643, which will cause the springs 649 to compress or expand to absorb the energy created by the rear wheels 114 contacting the feature 122. A spring rate of the springs 649 may control a rate of movement of the rotational brackets 645 relative to the support members.

FIGS. 7A and 7B illustrate an example of the robot 102 of FIG. 1 in which the mobility system 108 functions as a standing system, in accordance with at least one embodiment described in the present disclosure. With reference to FIGS. 1 and 7, the mobility system 108 may include support members 751 coupled to the wheels 114. The wheels 114 may include roller wheels at a front of the mobility system 108 and passive wheels at a rear of the mobility system 108. The rear wheels 114 may be coupled to rear distal ends of the support members 751. The mobility system 108 may also include swerve drives 753 that are coupled between the front wheels 114 and front distal ends of the support members 751.

The swerve drives 753 may include drive trains configured to independently drive and steer the front wheels 114. The swerve drives 753 may actively control and drive the front wheels 114 to provide locomotion forces for the robot 102. The swerve drives 753 may independently cause the front wheels 114 to rotate in a clockwise direction or a counterclockwise direction to cause the robot 102 to move forwards or backwards or to steer the robot 102. Additionally or alternatively, the swerve drives 753 may independently rotate around axes to change an orientation of the front wheels 114 to steer the robot 102.

The rear wheels 114 may include unpowered or non-driven wheels that rotate freely and/or provide omnidirectional movement. The rear wheels 114 may support and permit movement of the robot 102 but do not provide locomotion forces. The rear wheels 114 may rely on friction with a ground surface to move. In other words, the rear wheels 114 may rely on external forces due to the front wheels 114 moving the robot 102. As shown in FIGS. 7A and 7B, the rear wheels 114 include mecanum wheels to enable omnidirectional movement via rollers around circumferences of the wheels 114. Alternatively, the rear wheels 114 may include caster wheels or any other appropriate wheel to provide omnidirectional movement.

The swerve drives 753 and the wheels 114 may form an omnidirectional drivetrain. Additionally, the swerve drives 753 and the wheels 114 may provide holonomic translation of the robot 102. The swerve drives 753 and the wheels 114 providing omnidirectional movement or holonomic translation of the robot 102 may increase a precision of the positioning of the robot 102, reduce an amount of time to position the robot 102, or both.

The mobility system 108 may cause the robot 102 to transition between a default state (shown in FIG. 7A) and a standing state (shown in FIG. 7B). The mobility system 108 may cause the robot 102 to transition between the two states to adjust a height of the robot 102, reduce a footprint of the robot 102, or permit the robot 102 to traverse features of the environment 100. For example, the mobility system 108 may cause the robot 102 to transition to the standing state to reduce the footprint of the robot 102 when entering an area with limited space (e.g., an elevator that is occupied by humans, other robots, or any other appropriate item).

The mobility system 108 may include a bar 755, a pulley 757, a belt 759, or an actuator 761. The bar 755 may be coupled to the support members 751. The pulley 757 may be coupled to the swerve drives 753. In addition, the belt 759 may be coupled to the pulley 757 and the actuator 761. The actuator 761 may be coupled to a left support member 751 (e.g., the support member 751 closest to the viewer of FIGS. 7A and 7B).

The actuator 761 may drive the left support member 751 to cause the left support member 751 to change an orientation relative to a ground surface. In addition, the rotation of the left support member 751 may cause the bar 755 to move a right support member 751 and change its orientation relative to the ground surface. Accordingly, the mobility system 108 may cause the support members 751 to transition between the default state and the standing state. For example, the actuator 761 may cause the left support member 751 and the bar 755 may cause the right support member 751 to rotate in a counterclockwise direction to cause the robot 102 to transition from the default state to the standing state. As another example, the actuator 761 may cause the left support member 751 and the bar 755 may cause the right support member 751 to rotate in a clockwise direction to cause the robot 102 to transition from the standing state (shown in FIG. 7B) to the default state (shown in FIG. 7A).

Additionally, the actuator 761 may drive the belt 759 to cause the pulley 757 to rotate and move a left swerve drive 753 relative to the left support member 751. Additionally, the bar 755 may be coupled to another belt (not shown), which may in turn be coupled to another pulley (not shown). The bar 755 may drive the another belt to cause the another pulley to rotate and move a right swerve drive 753 relative to the right support member 751 in a same or similar manner as described in relation to the belt 759 and pulley 757. The actuator 761 and/or the bar 755 may drive the belts (e.g., the belt 759) to generally maintain an orientation of the swerve drives 753 relative to the ground surface. As used herein, the phrase “generally maintained” may include maintaining an angle relative to the ground surface within plus or minus ten degrees when transitioning between or in the standing state and the default state.

The actuator 761 may drive the support members 751 and/or the swerve drives 753 to shift a center mass of the robot 102 relative to the front wheels 114 to bring the swerve drives 753 under the center of mass of the robot 102.

FIG. 8 illustrates an example computing system 800 that may be used to control the mobility system of the robot 102 of FIG. 1, in accordance with at least one embodiment of the present disclosure. The computing system 800 may be configured to implement or direct one or more operations associated with the computing device 106. The computing system 800 may include a processor 802, a memory 804, a data storage 806, and a communication unit 808, which all may be communicatively coupled. In some embodiments, the computing system 800 may be part of any of the systems or devices described in this disclosure. For example, the computing system 800 may be configured to perform one or more of the tasks described above with respect to the computing device 106.

The processor 802 may include any computing entity, or processing device including various computer hardware or software modules and may be configured to execute instructions stored on any applicable computer-readable storage media. For example, the processor 802 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 8, it is understood that the processor 802 may include any number of processors distributed across any number of networks or physical locations that are configured to perform individually or collectively any number of operations described herein.

In some embodiments, the processor 802 may be configured to interpret and/or execute program instructions and/or process data stored in the memory 804, the data storage 806, or the memory 804 and the data storage 806. In some embodiments, the processor 802 may fetch program instructions from the data storage 806 and load the program instructions in the memory 804. After the program instructions are loaded into memory 804, the processor 802 may execute the program instructions.

For example, in some embodiments, the processor 802 may be configured to interpret and/or execute program instructions and/or process data stored in the memory 804, the data storage 806, or the memory 804 and the data storage 806. The program instruction and/or data may be related to an a mobility system such that the computing system 800 may perform or direct the performance of the operations associated therewith as directed by the instructions.

The memory 804 and the data storage 806 may include computer-readable storage media or one or more computer-readable storage mediums for carrying or having computer-executable instructions or data structures stored thereon. Such computer-readable storage media may be any available media that may be accessed by a computer, such as the processor 802.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a computer. Combinations of the above may also be included within the scope of computer-readable storage media.

Computer-executable instructions may include, for example, instructions and data configured to cause the processor 802 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500F.3d 1346 (Fed. Cir. 2007). Combinations of the above may also be included within the scope of computer-readable media.

The communication unit 808 may include any component, device, system, or combination thereof that is configured to transmit or receive information over a network. In some embodiments, the communication unit 808 may communicate with other devices at other locations, the same location, or even other components within the same system. For example, the communication unit 808 may include a modem, a network card (wireless or wired), an infrared communication device, a wireless communication device (such as an antenna implementing 4G (LTE), 4.5G (LTE-A), and/or 5G (mmWave) telecommunications), and/or chipset (such as a Bluetooth® device (e.g., Bluetooth 5 (Bluetooth Low Energy)), an 802.6 device (e.g., Metropolitan Area Network (MAN)), a Wi-Fi device (e.g., IEEE 802.11ax, a WiMAX device, cellular communication facilities, etc.), and/or the like. The communication unit 808 may permit data to be exchanged with a network and/or any other devices or systems described in the present disclosure.

Modifications, additions, or omissions may be made to the computing system 800 without departing from the scope of the present disclosure. For example, in some embodiments, the computing system 800 may include any number of other components that may not be explicitly illustrated or described. Further, depending on certain implementations, the computing system 800 may not include one or more of the components illustrated and described.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A robot comprising
a body; and
a mobility system comprising:
a multi-link system coupled to the body, the multi-link system forming a kinematic chain to control movement of the multi-link system; and
an actuator coupled to a particular link of the multi-link system, the actuator configured to drive the particular link and move the multi-link system in a single dimension relative to the body for interaction of the robot with a feature.

2. The robot of claim 1, wherein:
the actuator comprises a first actuator and the particular link comprises a first link;
the mobility system comprises a second actuator coupled to a second link of the multi-link system; and
the second actuator is configured to drive the second link to move the multi-link system in an additional dimension relative to the body for the interaction of the robot with the feature.

3. The robot of claim 2, wherein the first actuator is configured to drive the first link and the second actuator is configured to drive the second link to:
control an orientation of the body relative to a surface;
raise or lower the body relative to the surface; or
step on or over the feature.

4. The robot of claim 3, wherein:
the mobility system comprises a wheel;
the first actuator is configured to drive the first link to cause the wheel to move in a vertical direction; and
the second actuator is configured to drive the second link to cause the wheel to move in a horizontal direction.

5. The robot of claim 1, wherein the multi-link system comprises multiple links connected via joints to permit the links to pivot or rotate relative to the joints to adjust an angle, an orientation, or a position of the multi-link system.

6. The robot of claim 1, wherein:
the multi-link system comprises a first multi-link system coupled to a first side of the body;
the mobility system comprises a second multi-link system coupled to a second side of the body; and
the first multi-link system and the second multi-link system are configured to operate independently.

7. The robot of claim 6, wherein:
the mobility system comprises a third multi-link system coupled to the first side of the body; and
the first multi-link system and the second multi-link system are configured to independently move to control a position of a center of mass of the robot to account for a shift in weight of the robot when moving the third multi-link system.

8. The robot of claim 1, wherein:
the mobility system comprises a belt coupled to the actuator and the particular link; and
the actuator is configured to cause the belt to rotate to drive the particular link.

9. The robot of claim 1, wherein:
the mobility system comprises a passive component coupled to at least two links of the multi-link system; and
the passive component is configured to absorb or release energy due to the mobility system physically contacting the feature.

10. The robot of claim 9, wherein the passive component comprises:
a spring coupled to two links of the multi-link system; or
a torsion device coupled to the particular link, the torsion device configured to store or release energy due to the robot contacting the feature.

11. A robot comprising
a body; and
a mobility system comprising:
a virtual four bar link system comprising a first link and a second link, the first link coupled to the body and the second link coupled to the first link; and
an actuator coupled to the first link, the actuator configured to drive the first link to move the virtual four bar link system relative to the body in multiple dimensions for interaction of the robot with a feature.

12. The robot of claim 11, wherein the mobility system comprises:
a passive component coupled to the second link; and
a belt coupled to the passive component and the actuator.

13. The robot of claim 11, wherein the actuator is configured to drive the first link to:
control an orientation of the body relative to a surface;
raise or lower the body relative to the surface; or
adjust a center of mass of the robot.

14. The robot of claim 11, wherein:
the mobility system comprises a wheel; and
the actuator is configured to drive the first link to cause the wheel to move in a vertical direction and to move in a horizontal direction.

15. The robot of claim 14, wherein the mobility system operates as a holonomic drive system.

16. The robot of claim 11, wherein the virtual four bar link system comprises multiple links connected via joints to permit the multiple links to pivot or rotate relative to the joints to adjust an angle, an orientation, or a position of the virtual four bar link system.

17. The robot of claim 11, wherein:
the virtual four bar link system comprises a first virtual four bar link system coupled to a first side of the body;
the mobility system comprises a second virtual four bar link system coupled to a second side of the body; and
the first virtual four bar link system and the second virtual four bar link system are configured to operate independently.

18. The robot of claim 17, wherein:
the mobility system comprises a third virtual four bar link system coupled to the first side of the body; and
the first virtual four bar link system and the second virtual four bar link system are configured to independently move to control a position of a center of mass of the robot to account for a shift in weight of the robot when moving the third virtual four bar link system.

19. The robot of claim 11, wherein the actuator is positioned:
on or within the body; or
on or within the first link.

20. The robot of claim 11, wherein the virtual four bar link system is configured to maintain a vertical orientation of the second link while the virtual four bar link system is moving.
